(19) United States
(12) Patent Application Publication
(10) Pub. No.: US 2026/0257377 A1
(43) Pub. Date: Sep. 3, 2026

(54) CONNECTING DEVICE AND MAGNETIC GRIPPER COMPRISING SUCH A CONNECTING DEVICE

(71) Applicant: ECM TECHNOLOGIES, GRENOBLE (FR)

(72) Inventor: Chakib BENSAID, CASTELNAU-LE-LEZ (FR)

(21) Appl. No.: 18/846,880

(22) PCT Filed: Mar. 7, 2023
(86) PCT No.: PCT/EP2023/055681

§ 371 Date: Sep. 13, 2024

(30) Foreign Application Priority Data
Mar. 29, 2022 (FR) FR2202816

(51) Int. Cl. B25J 15/06; B25J 19/00

(52) U.S. Cl. CPC B25J 15/0608; B25J 19/0075

(57) ABSTRACT

The present description concerns a linking device (20) for a magnetic gripper comprising a membrane (22) having first and second opposite surfaces (24, 26), a ring-shaped portion (28) projecting from the second surface along the periphery of the membrane and deformable fastening means (40) projecting from the ring-shaped portion.

The present patent application claims the priority benefit of French patent application FR22/02816 which is herein incorporated by reference.

### TECHNICAL BACKGROUND

The present disclosure generally concerns linking devices for a magnetic gripper and magnetic grippers comprising such linking devices.

### PRIOR ART

Magnetic grippers are used for the handling of ferromagnetic mechanical parts. An example of application is the automobile field where magnetic grippers are used to handle mechanical parts such as pinions, hubs, etc. For this purpose, the magnetic gripper is taken close to the mechanical part to be handled, a magnet device of the gripper is then actuated so that the mechanical part adheres to the gripper by magnetic attraction. When the mechanical part is taken to the desired position, the magnet device is deactivated to release the mechanical part.

The handling of the mechanical part by the gripper must not damage the mechanical part. It is further desirable to be able to use a same gripper with mechanical parts of different dimensions. The intensity of the magnetic field decreases with the distance with respect to the gripper head. The manufacturing cost of the magnetic gripper depends in particular on the maximum intensity of the magnetic field generated by the magnet device of the gripper. It is desirable for the manufacturing cost of the magnetic gripper to be decreased, which implies that the handled mechanical part is as close as possible to the gripper head so that the attraction forces exerted on the mechanical part allow the handling thereof without requiring the generation of a magnetic field of high intensity.

### SUMMARY OF THE INVENTION

Thus, an object of an embodiment is to overcome all or part of the disadvantages of known magnetic grippers.

Another object of an embodiment is to be able to use the magnetic gripper with mechanical parts of different sizes.

Another object is to avoid a direct physical contact between the mechanical part and a rigid portion, particularly metallic, of the magnetic gripper, in particular with mechanical parts of different sizes.

For this purpose, an embodiment provides a linking device for a magnetic gripper comprising a membrane having first and second opposite surfaces, a ring-shaped portion projecting from the second surface along the periphery of the membrane and deformable fastening means projecting from the ring-shaped portion.

According to an embodiment, the membrane and the ring-shaped portion form a monoblock part.

According to an embodiment, the fastening means comprise a deformable lip.

According to an embodiment, the membrane and the ring-shaped portion are made of a flexible material.

According to an embodiment, the thickness of the membrane is in the range from 0.05 mm to 5 mm.

According to an embodiment, the thickness of the ring-shaped portion is in the range from 5 mm to 15 mm.

According to an embodiment, the maximum lateral dimension of the membrane is in the range from 10 mm to 100 mm.

According to an embodiment, the linking device comprises an axis of symmetry of revolution.

An embodiment also provides a magnetic gripper comprising a magnetic gripping device and a linking device such as previously defined.

According to an embodiment, the magnetic gripping tool comprises a head having a third surface, the membrane entirely covering the third surface, the second surface being in physical contact with the third surface.

According to an embodiment, the third surface is planar.

According to an embodiment, the magnetic gripper comprises a groove into which the deformable fastening means at least partially penetrate.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1 is a partially exploded perspective view of an embodiment of a magnetic gripper;

FIG. 2 is a side view of the gripper of FIG. 1;

FIG. 3 is a lateral cross-section view of the gripper of FIG. 1;

FIG. 4 is a detail view of FIG. 3;

FIG. 5 is a perspective view of an embodiment of a linking device of the gripper of FIG. 1;

FIG. 6 is a top view of the linking device of FIG. 5;

FIG. 7 is a lateral cross-section view of the linking device of FIG. 5;

FIG. 8 is a cross-section view of a portion of the gripper of FIG. 1 during the handling of an object of small dimension;

FIG. 9 is a cross-section view of a portion of the gripper of FIG. 1 during the handling of an object of average dimension; and

FIG. 10 is a cross-section view of a portion of the gripper of FIG. 1 during the handling of an object of large dimension.

### DESCRIPTION OF THE EMBODIMENTS

Like features have been designated by like references in the various figures. In particular, the structural and/or functional features that are common among the various embodiments may have the same references and may dispose identical structural, dimensional and material properties.

For the sake of clarity, only the steps and elements that are useful for an understanding of the embodiments described herein have been illustrated and described in detail. In particular, the structure of a magnetic gripper has not been detailed.

In the following description, when reference is made to terms qualifying absolute positions, such as terms “front”, “rear”, “top”, “bottom”, “left”, “right”, etc., or relative positions, such as terms “above”, “under”, “upper”, “lower”, etc., or to terms qualifying directions, such as terms “horizontal”, “vertical”, etc., it is referred to the orientation of the drawings or to a . . . in a normal position of use.

Unless specified otherwise, the expressions “around”, “approximately”, “substantially” and “in the order of” signify within 10%, and preferably within 5%.

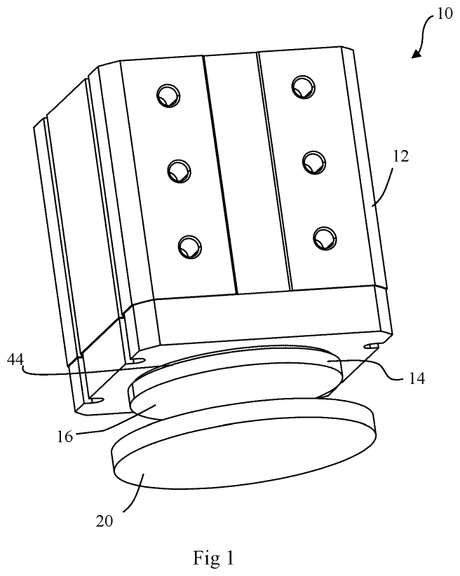

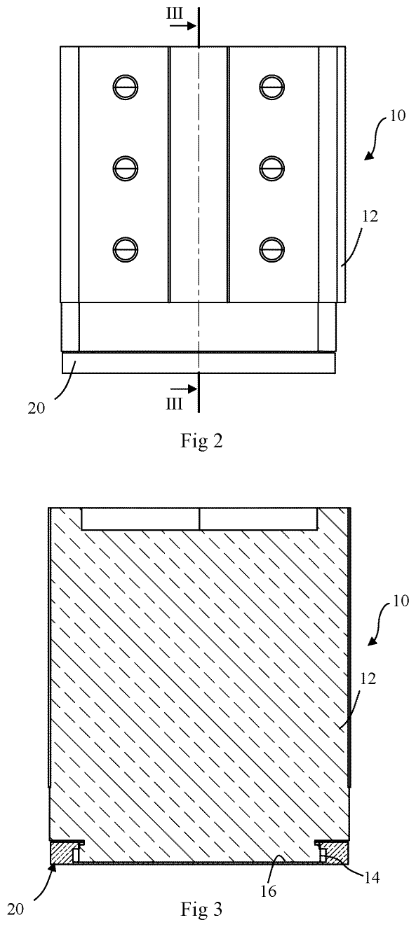

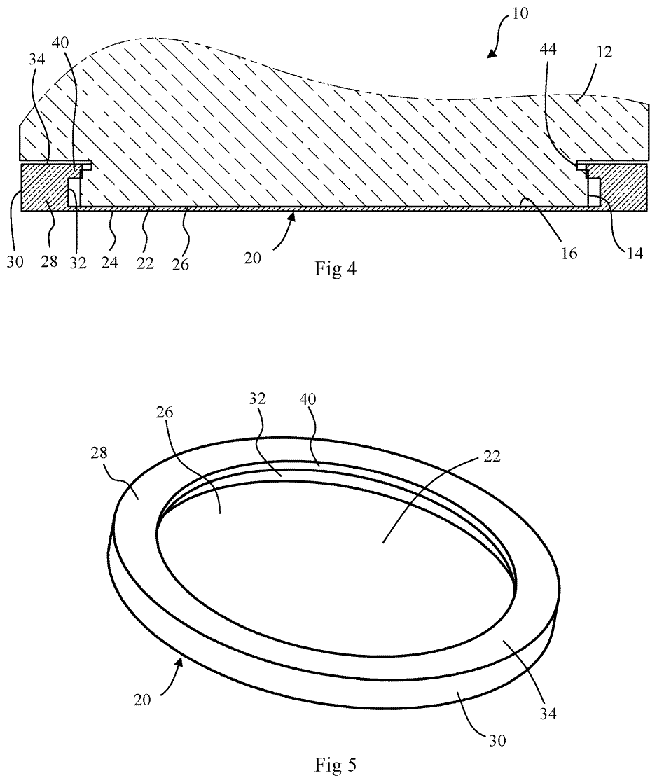

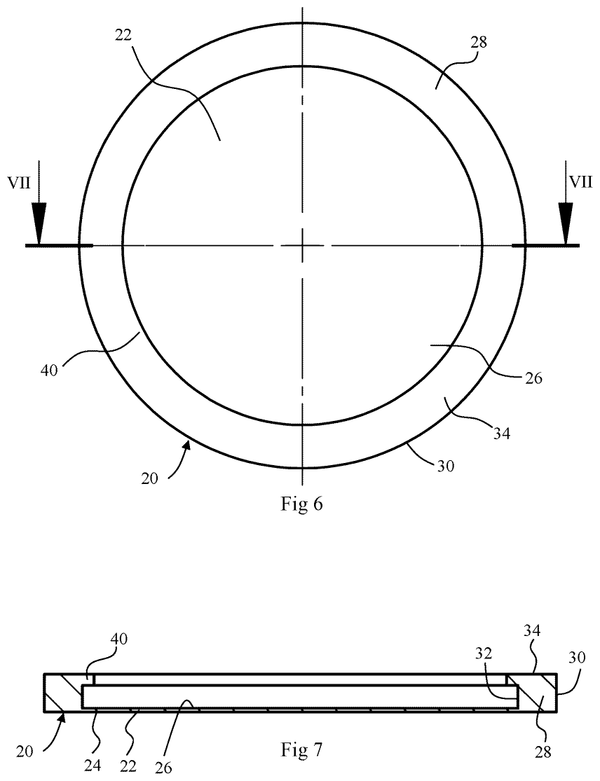

FIG. 1 is a simplified and partially exploded perspective view of an embodiment of a magnetic gripper 10. FIG. 2 is a partial and simplified side view of gripper 10. FIG. 3 is a cross-section view of FIG. 2 along cross-section plane III-III. FIG. 4 is a detail view of FIG. 3.

Magnetic gripper 10 comprises a magnetic gripping tool 12 and a linking device 20. Gripping tool 12 may be displaced by an actuating system, not shown, for example, a robotic arm. Gripping tool 12 particularly comprises a gripping head 14 having a surface 16, preferably planar. According to an embodiment, head 14 corresponds to a cylindrical part with a circular base. Head 14 may be made of a ferromagnetic material. Linking device 20 is arranged on head 14 and particularly covers surface 16.

The inner structure of gripping tool 12 is not shown in the cross-section views. According to an embodiment, gripping tool 12 comprises an enclosure containing a permanent magnet and a jack, for example, a pneumatic jack or an electric jack, adapted to displacing the magnet inside of the enclosure to take the magnet towards or away from head 14. The gripping of a mechanical part is obtained by taking the magnet closer to the head. According to an embodiment, the enclosure of gripping tool 12 comprises an electro-magnet for the generation of the magnetic field for attracting the mechanical part to be displaced.

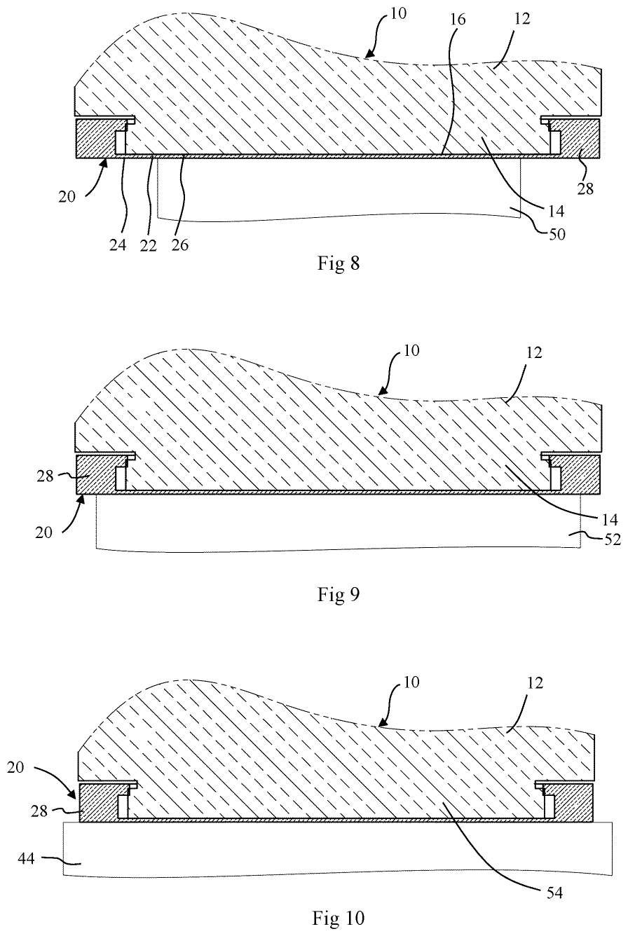

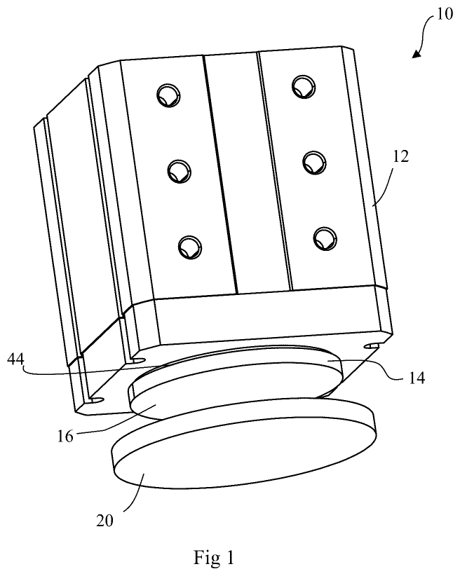

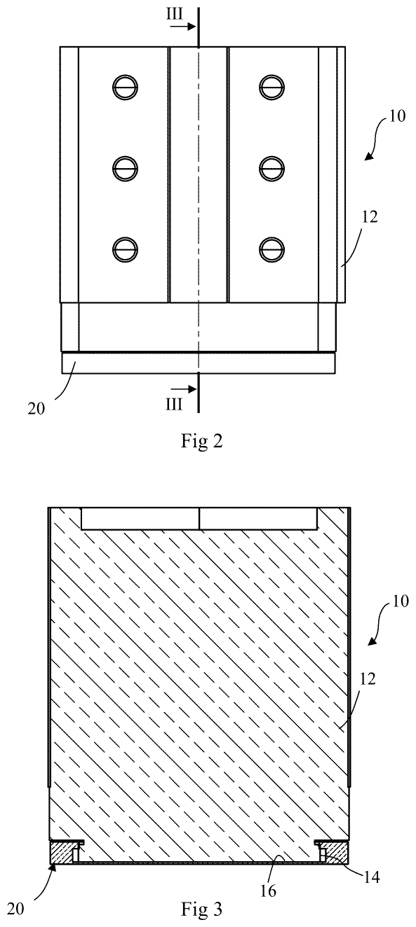

FIG. 5 is a partial and simplified perspective view of an embodiment of linking device 20. FIG. 6 is a partial simplified top view of linking device 20. FIG. 7 is a cross-section view of FIG. 6 along cross-section planar VII-VII.

Linking device 20 comprises a membrane 22 delimiting a front surface 24 and a rear surface 26 opposite to front surface 24. According to an embodiment, when linking device 20 is assembled on head 14, front surface 24 is substantially planar and rear surface 26 is in physical contact with the surface 16 of head 14. As a variant, surface 24 is not planar. Surface 24 for example comprises protrusions intended to improve the bonding between linking device 20 and the part to be displaced, particularly during a lateral linear motion. Front surface 24 is intended to be in contact with the part to be handled by gripper 10. According to an embodiment, membrane 22 comprises no through opening. According to an embodiment, the thickness of membrane 22 is in the range from 0.05 mm to 5 mm.

Linking device 20 comprises a ring-shaped portion 28 extending along the periphery of membrane 22. Preferably, ring-shaped portion 28 extends over the entire periphery of membrane 22. Ring-shaped portion 28 comprises an inner lateral wall 30, an outer lateral wall 32, a rear edge 34. According to an embodiment, ring-shaped portion 28 projects from the rear surface 26 of membrane 22. Preferably, linking device 20 comprises no elements protruding from front surface 24. Rear edge 34 may correspond to a planar surface. Ring-shaped 28 has a shape complementary to head 14. According to an embodiment, when head 14 corresponds to a cylindrical part with a circular base, ring-shaped portion 28 may be of circular shape. Inner lateral wall 30 and outer lateral wall 32 may then correspond to cylindrical walls with a circular base. Further, linking device 20 may then have a symmetry of revolution.

Generally, the dimensions of ring-shaped portion 28 depend on those of head 14, and thus on the dimensions of the parts to be handled. According to an embodiment, when ring-shaped portion 28 has a circular shape, ring-shaped portion 28 comprises an inner diameter in the range from 10 mm to 100 mm and an outer diameter in the range from 25 mm to 70 mm. According to an embodiment, the thickness of ring-shaped portion 28, measured perpendicularly to front surface 24, is in the range from 5 mm to 15 mm.

Linking device 20 comprises means for fastening linking device 20 to the head 14 of gripping tool 12. According to an embodiment, the fastening means comprise a lip 40 projecting towards head 14, from the inner wall 30 of ring-shaped portion 28 in line with the rear edge 34 of ring-shaped portion 28. The fastening of linking device 20 on gripping head 14 may be achieved by the deformation of lip 40. In FIG. 4, lip 40 is shown as non-deformed, whereby a partial overlapping with head 14. Gripping tool 12 may comprise a groove 44 at the base of the head into which lip 40 can at least partially penetrate. The cooperation of lip 40 in groove 44 improves the holding of linking device 12.

In the embodiment illustrated in FIGS. 5 and 6, lip 40 is present over the entire junction between inner wall 30 and rear edge 34. As a variant, continuous lip 40 may be replaced with a plurality of distinct lips, each projecting towards head 14, from the inner wall 30 of ring-shaped portion 28 in line with the rear edge 34 of ring-shaped portion 28.

According to an embodiment, linking device 20 is a monoblock part. According to an embodiment, linking device 20 is made of a flexible material. According to an embodiment, the Shore A hardness of the material forming linking device 20 is in the range from 50 Shore A to 65 Shore A. The measurement of the Shore A hardness may be performed according to ISO standard 48-4:2018. Linking device 20 may be made of a polymer. Linking device 20 may be made of polyurethane. According to an embodiment, linking device 20 is manufactured by casting. According to an embodiment, linking device 20 is manufactured by three-dimensional printing.

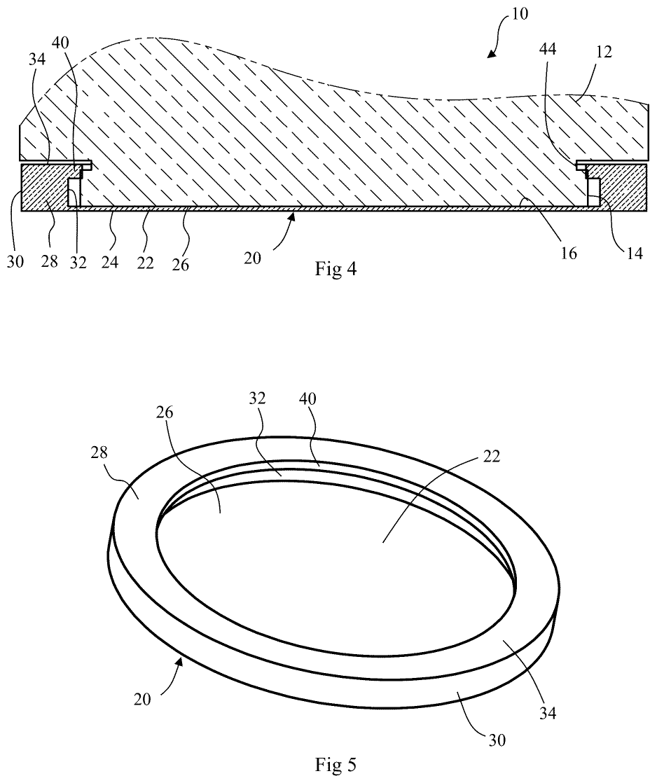

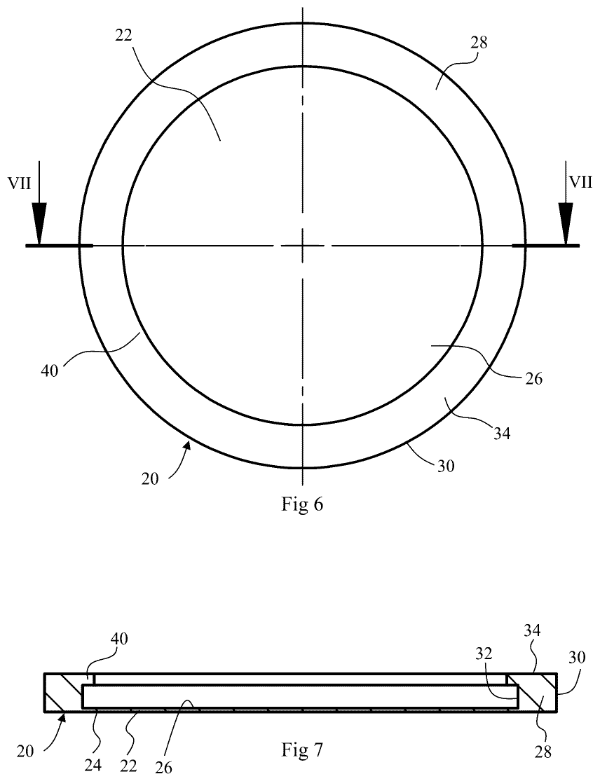

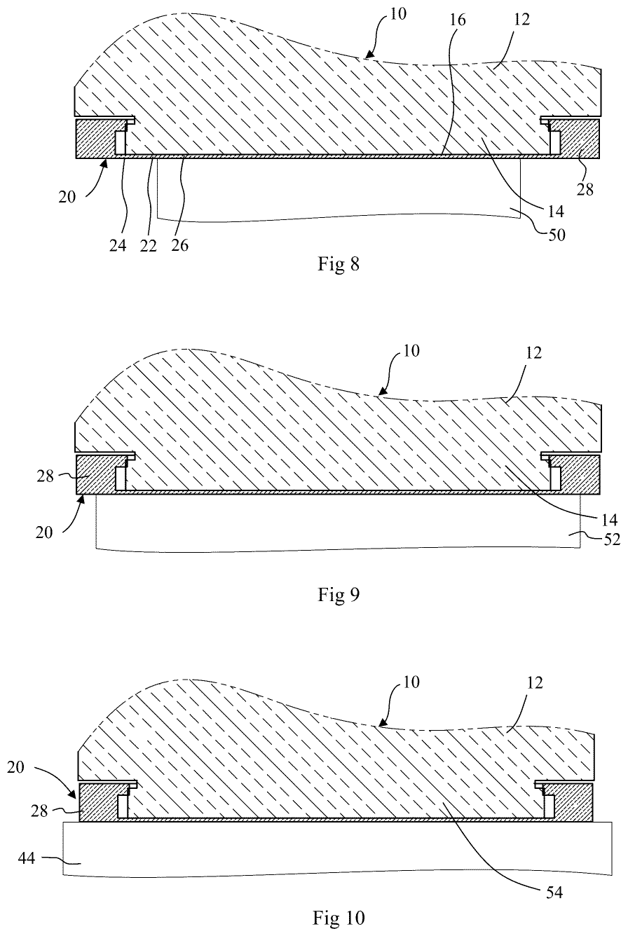

FIGS. 8, 9, and 10 are views similar to FIG. 4 illustrating the handling of mechanical parts 50, 52, 54 of different dimensions by magnetic gripper 10. As illustrated in these drawings, gripper 10 may be used to handle a mechanical part 50 having a lateral dimension smaller than the lateral dimension of head 14, a mechanical part 52 having a lateral dimension smaller than the lateral dimension of head 14 and smaller than the lateral dimension of linking device 12, or a mechanical part 54 having a lateral dimension smaller than the lateral dimension of head 14 and greater than the lateral dimension of linking device 12. The presence of membrane 22 enables to avoid for the mechanical part 50 to be displaced to come in direct contact with the head, even when the lateral dimension of mechanical part 50 is smaller than the lateral dimension of head 14. Further, the reduced thickness of membrane 22 enables the mechanical part 50, 52, 54 to be displaced to remain close to the front surface 16 of head 14, where the magnetic field has a maximum intensity outside of gripper 10.

Various embodiments and variants have been described. Those skilled in the art will understand that certain features of these various embodiments and variants may be combined, and other variants will occur to those skilled in the art. Finally, the practical implementation of the described embodiments and variations is within the abilities of those skilled in the art based on the functional indications given hereabove.

1. Linking device for a magnetic gripper comprising a membrane having first and second opposite surfaces, a ring-shaped portion projecting from the second surface along the periphery of the membrane and deformable fastening means projecting from the ring-shaped portion.

2. Linking device according to claim 1, wherein the membrane and the ring-shaped portion form a monoblock part.

3. Linking device according to claim 1, wherein the linking means comprise a deformable lip.

4. Linking device according to claim 1, wherein the membrane and the ring-shaped portion are made of a flexible material.

5. Linking device according to claim 1, wherein the thickness of the membrane is in the range from 0.05 mm to 5 mm.

6. Linking device according to claim 1, wherein the thickness of the ring-shaped portion is in the range from 5 mm to 15 mm.

7. Linking device according to claim 1, wherein the maximum lateral dimension of the membrane is in the range from 10 mm to 100 mm.

8. Linking device according to claim 1, comprising an axis of symmetry of revolution.

9. Magnetic gripper comprising a magnetic gripping tool and a linking device according to claim 1.

10. Magnetic gripper according to claim 9, wherein the magnetic gripping tool comprises a head having a third surface, the membrane entirely covering the third surface, the second surface being in physical contact with the third surface.

11. Magnetic gripper according to claim 9, wherein the third surface is planar.

12. Magnetic gripper according to claim 9, comprising a groove into which the deformable fastening means at least partially penetrate.
